(19) United States
(12) Patent Application Publication
(10) Pub. No.: US 2007/0025706 A1
(43) Pub. Date: Feb. 1, 2007

(54) Method and apparatus for reproducing data, recording medium, and method and apparatus for recording data

(75) Inventors: Kun Suk Kim, Anyang-si (KR); Jea Yong Yoo, Seongnam-si (KR)

Correspondence Address: HARNESS, DICKEY & PIERCE, P.L.C., P.O. BOX 8910, RESTON, VA, 20195, US

(73) Assignee: LG Electronics Inc.

(21) Appl. No.: 11/493,900

(22) Filed: Jul. 27, 2006

Related U.S. Application Data
(60) Provisional application No. 60/703,465, filed on Jul. 29, 2005.
(60) Provisional application No. 60/703,466, filed on Jul. 29, 2005.
(60) Provisional application No. 60/716,523, filed on Sep. 14, 2005.
(60) Provisional application No. 60/737,412, filed on Nov. 17, 2005.

(30) Foreign Application Priority Data
Apr. 3, 2006 (KR) 1020060030105

(51) Int. Cl. H04N 7/26

(52) U.S. Cl. 386/112

(57) ABSTRACT

In one embodiment, a primary video stream in data reproduced from the recording medium is decoded using a first decoder, and a secondary video stream in the reproduced data is decoded using a second decoder. The secondary video stream represents picture-in-picture video data with respect to the primary video stream.

### DOMESTIC PRIORITY INFORMATION

This application claims the benefit of the U.S. Provisional Application Nos. 60/703,466, 60/703,465, 60/716,523 and 60/737,412 filed Jul. 9, 2005, Jul. 29, 2005, Sep. 14, 2005 and Nov. 17, 2005, which are all hereby incorporated by reference in their entirety.

### FOREIGN PRIORITY INFORMATION

This application claims the benefit of the Korean Patent Application No. 10-2006-0030105, filed on Apr. 3, 2006, which is hereby incorporated by reference in its entirety.

### BACKGROUND OF THE INVENTION

1. Field of the Invention

The present invention relates to recording and reproducing methods and apparatuses, and a recording medium.

2. Discussion of the Related Art

Optical discs are widely used as a recording medium capable of recording a large amount of data therein. Particularly, high-density optical recording mediums such as a Blu-ray Disc (BD) and a high definition digital versatile disc (HD-DVD) have recently been developed, and are capable of recording and storing large amounts of high-quality video data and high-quality audio data.

Such a high-density optical recording medium, which is based on next-generation recording medium techniques, is considered to be a next-generation optical recording solution capable of storing much more data than conventional DVDs. Development of high-density optical recording mediums is being conducted, together with other digital appliances. Also, an optical recording/reproducing apparatus, to which the standard for high density recording mediums is applied, is under development.

In accordance with the development of high-density recording mediums and optical recording/reproducing apparatuses, it is possible to simultaneously reproduce a plurality of videos. However, there is known no method capable of effectively simultaneously recording or reproducing a plurality of videos. Furthermore, it is difficult to develop a complete optical recording/reproducing apparatus based on high-density recording mediums because there is no completely-established standard for high-density recording mediums.

### SUMMARY OF THE INVENTION

The present invention relates to method of decoding picture-in-picture video data reproduced from a recording medium.

In one embodiment, a primary video stream in data reproduced from the recording medium is decoded using a first decoder, and a secondary video stream in the reproduced data is decoded using a second decoder. The secondary video stream represents picture-in-picture video data with respect to the primary video stream.

In one embodiment, the method further includes reproducing a main path data stream from a data file recorded on the recording medium. The main data stream includes the primary and secondary video streams. This embodiment may further include separating the primary video stream from the main data stream, and separating the secondary video stream from the main data stream.

In one embodiment, whether the secondary video stream is recorded in a same data file as the primary video stream based on type information recorded on the recording medium is determined, and the main data stream is reproduced based on the determining step.

In another embodiment, a main path data stream is reproduced from a first data file recorded on the recording medium. The main path data stream includes the primary video stream. Also, a sub path data stream is reproduced from a second data file recorded on the recording medium. The second data file is separate from the first data file, and the sub path data stream includes the secondary video stream. This embodiment may include separating the primary video stream from the main path data stream, and separating the secondary video stream from the sub path data stream.

In one embodiment, whether the secondary video stream is recorded in a same data file as the primary video stream or a data file separate from the primary video stream is determined based on type information recorded on the recording medium.

Yet another embodiment further includes displaying the secondary video stream synchronously with the primary video stream based on type information recorded on the recording medium.

A further embodiment includes displaying the secondary video stream synchronously with the primary video stream based on type information recorded on the recording medium.

In one embodiment, a sum of bit rates of the primary and secondary video streams is less than or equal to a set value.

In another embodiment, the secondary video stream has a same scan type as the primary video stream.

Yet another embodiment of a method of decoding picture-in-picture video data includes decoding a primary video stream in data reproduced from a recording medium using a first decoder. The method further includes receiving the sub path data stream from an external source other than the recording medium, storing the sub path data stream including at least a secondary video stream, and decoding the secondary video stream using a second decoder. The secondary video stream predetermined to serve as a picture-in-picture data with respect to the primary video stream.

The present invention also relates to a method of processing picture-in-picture video data reproduced from a recording medium. One embodiment of this method includes separating a primary video stream from a main path data stream reproduced from the recording medium, and supplying the primary video stream to a first decoder. The embodiment further includes separating a secondary video stream from one of the main path data stream and a sub path data stream reproduced from the recording medium, and supplying the secondary video stream to a second decoder. The secondary video stream represents picture-in-picture video data with respect to the primary video stream.

The present invention further relates to methods and apparatuses for recording picture-in-picture video data on a recording medium, an apparatus for decoding picture-in-picture video data reproduced from a recording medium, and the recording medium.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principles of the invention. In the drawings:

FIG. 1 is a schematic view illustrating an exemplary embodiment of the combined use of an optical recording/reproducing apparatus according to an embodiment of the present invention and a peripheral appliance;

FIG. 2 is a schematic diagram illustrating a structure of files recorded in an optical disc as a recording medium according to an embodiment of the present invention;

FIG. 3 is a schematic diagram illustrating a data recording structure of the optical disc as the recording medium according to an embodiment of the present invention;

FIG. 4 is a schematic diagram for understanding a concept of a secondary video according to an embodiment of the present invention;

FIG. 5 is a block diagram illustrating an overall configuration of an optical recording/reproducing apparatus according to an embodiment of the present invention;

FIG. 6 is a block diagram schematically illustrating an exemplary embodiment of a playback system according to an embodiment of the present invention;

FIG. 7 is a schematic diagram illustrating an AV decoder according to an embodiment of the present invention;

FIG. 8A is a schematic diagram illustrating a first embodiment of the encoding type of the secondary video according to the present invention;

FIG. 8B is a schematic diagram illustrating a second embodiment of the encoding type of the secondary video according to the present invention;

FIGS. 9A to 9C are schematic diagrams illustrating various presentation path types for the secondary video according to an embodiment of the present invention, respectively; and

FIG. 10 is a flow chart illustrating an exemplary embodiment of a data reproducing method according to the present invention.

### DETAILED DESCRIPTION OF EXAMPLE EMBODIMENTS

Reference will now be made in detail to example embodiments of the present invention, which are illustrated in the accompanying drawings. Wherever possible, the same reference numbers will be used throughout the drawings to refer to the same or like parts.

In the following description, example embodiments of the present invention will be described in conjunction with an optical disc as an example recording medium. In particular, a Blu-ray disc (BD) is used as an example recording medium, for the convenience of description. However, it will be appreciated that the technical idea of the present invention is applicable to other recording mediums, for example, HD-DVD, equivalently to the BD.

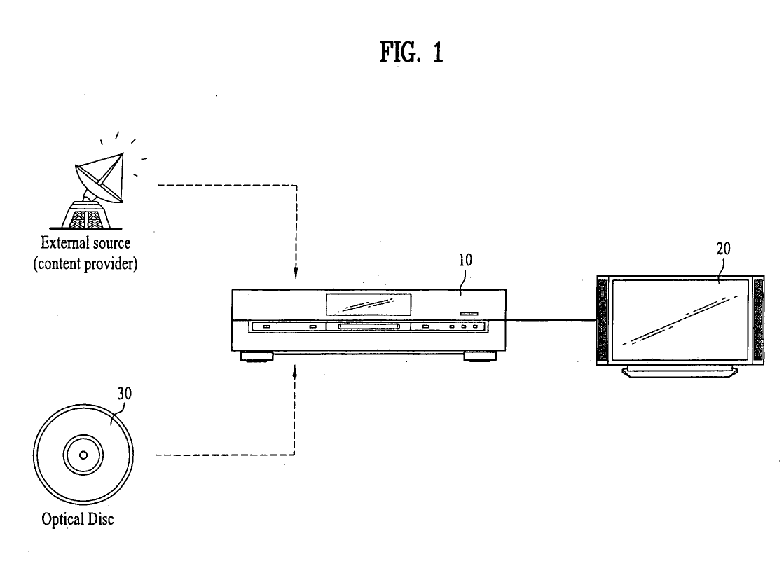

“Storage” as generally used in the embodiments is a storage equipped in a optical recording/reproducing apparatus (FIG. 1). The storage is an element in which the user freely stores required information and data, to subsequently use the information and data. For storages, which are generally used, there are a hard disk, a system memory, a flash memory, and the like. However, the present invention is not limited to such storages.

In association with the present invention, the “storage” is also usable as means for storing data associated with a recording medium (for example, a BD). Generally, the data stored in the storage in association with the recording medium is externally-downloaded data.

As for such data, it will be appreciated that partially-allowed data directly read out from the recording medium, or system data produced in association with recording and production of the recording medium (for example, metadata) can be stored in the storage.

For the convenience of description, in the following description, the data recorded in the recording medium will be referred to as “original data”, whereas the data stored in the storage in association with the recording medium will be referred to as “additional data”.

Also, “title” defined in the present invention means a reproduction unit interfaced with the user. Titles are linked with particular objects, respectively. Accordingly, streams recorded in a disc in association with a title are reproduced in accordance with a command or program in an object linked with the title. In particular, for the convenience of description, in the following description, among the titles including video data according to an MPEG compression scheme, titles supporting features such as seamless multi-angle and multi story, language credits, director's cuts, trilogy collections, etc. will be referred to as “High Definition Movie (HDMV) titles”. Also, among the titles including video data according to an MPEG compression scheme, titles providing a fully programmable application environment with network connectivity thereby enabling the content provider to create high interactivity will be referred to as “BD-J titles”.

FIG. 1 illustrates an exemplary embodiment of the combined use of an optical recording/reproducing apparatus according to the present invention and a peripheral appliance.

The optical recording/reproducing apparatus 10 according to an embodiment of the present invention can record or reproduce data in/from various optical discs having different formats. If necessary, the optical recording/reproducing apparatus 10 may be designed to have recording and reproducing functions only for optical discs of a particular format (for example, BD), or to have a reproducing function alone, except for a recording function. In the following description, however, the optical recording/reproducing apparatus 10 will be described in conjunction with, for example, a BD-player for playback of a BD, or a BD-recorder for recording and playback of a BD, taking into consideration the compatibility of BDs with peripheral appliances, which must be solved in the present invention. It will be appreciated that the optical recording/reproducing apparatus 10 of the present invention may be a drive which can be built in a computer or the like.

The optical recording/reproducing apparatus 10 of the present invention not only has a function for recording and playback of an optical disc 30, but also has a function for receiving an external input signal, processing the received signal, and sending the processed signal to the user in the form of a visible image through an external display 20. Although there is no particular limitation on external input signals, representative external input signals may be digital multimedia broadcasting-based signals, Internet-based signals, etc. Specifically, as to Internet-based signals, desired data on the Internet can be used after being downloaded through the optical recording/reproducing apparatus 10 because the Internet is a medium easily accessible by any person.

In the following description, persons who provide contents as external sources will be collectively referred to as a “content provider (CP)”.

“Content” as used in the present invention may be the content of a title, and in this case means data provided by the author of the associated recording medium.

Hereinafter, original data and additional data will be described in detail. For example, a multiplexed AV stream of a certain title may be recorded in an optical disc as original data of the optical disc. In this case, an audio stream (for example, Korean audio stream) different from the audio stream of the original data (for example, English) may be provided as additional data via the Internet. Some users may desire to download the audio stream (for example, Korean audio stream) corresponding to the additional data from the Internet, to reproduce the downloaded audio stream along with the AV stream corresponding to the original data, or to reproduce the additional data alone. To this end, it is desirable to provide a systematic method capable of determining the relation between the original data and the additional data, and performing management/reproduction of the original data and additional data, based on the results of the determination, at the request of the user.

As described above, for the convenience of description, signals recorded in a disc have been referred to as “original data”, and signals present outside the disc have been referred to as “additional data”. However, the definition of the original data and additional data is only to classify data usable in the present invention in accordance with data acquisition methods. Accordingly, the original data and additional data should not be limited to particular data. Data of any attribute may be used as additional data as long as the data is present outside an optical disc recorded with original data, and has a relation with the original data.

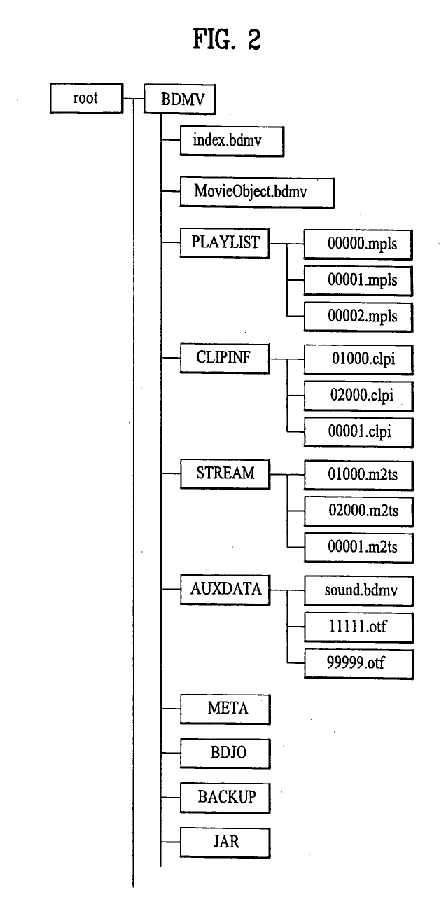

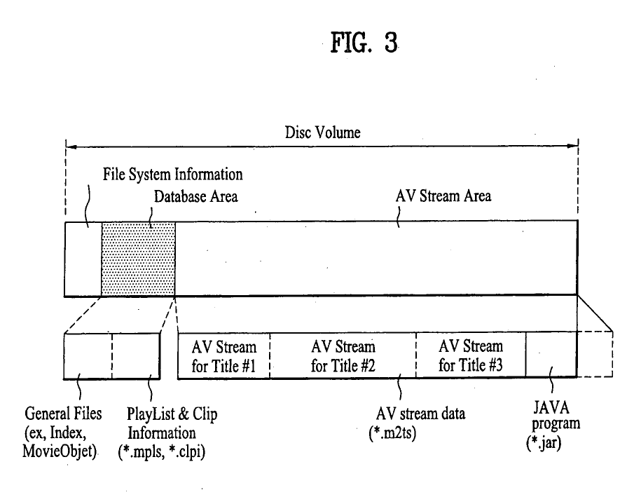

In order to accomplish the request of the user, the original data and additional data must have file structures having a relation therebetween, respectively. Hereinafter, file structures and data recording structures usable in a BD will be described with reference to FIGS. 2 and 3.

FIG. 2 illustrates a file structure for reproduction and management of original data recorded in a BD in accordance with an embodiment of the present invention.

The file structure of the present invention includes a root directory, and at least one BDMV directory BDMV present under the root directory. In the BDMV directory BDMV, there are an index file “index.bdmv” and an object file “MovieObject.bdmv” as general files (upper files) having information for securing an interactivity with the user. The file structure of the present invention also includes directories having information as to the data actually recorded in the disc, and information as to a method for reproducing the recorded data, namely, a playlist directory PLAYLIST, a clip information directory CLIPINF, a stream directory STREAM, an auxiliary directory AUXDATA, a BD-J directory BDJO, a metadata directory META, a backup directory BACKUP, and a JAR directory. Hereinafter, the above-described directories and files included in the directories will be described in detail.

The JAR directory includes JAVA program files.

The metadata directory META includes a file of data about data, namely, a metadata file. Such a metadata file may include a search file and a metadata file for a disc library. Such metadata files are used for efficient search and management of data during the recording and reproduction of data.

The BD-J directory BDJO includes a BD-J object file for reproduction of a BD-J title.

The auxiliary directory AUXDATA includes an additional data file for playback of the disc. For example, the auxiliary directory AUXDATA may include a “Sound.bdmv” file for providing sound data when an interactive graphics function is executed, and “11111.otf” and “99999.otf” files for providing font information during the playback of the disc.

The stream directory STREAM includes a plurality of files of AV streams recorded in the disc according to a particular format. Most generally, such streams are recorded in the form of MPEG-2-based transport packets. The stream directory STREAM uses “*.m2ts” as an extension name of stream files (for example, 01000.m2ts, 02000.m2ts, . . . ). Particularly, a multiplexed stream of video/audio/graphic information is referred to as an “AV stream”. A title is composed of at least one AV stream file.

The clip information (clip-info) directory CLIPINF includes clip-info files 010000.clpi, 02000.clpi, . . . respectively corresponding to the stream files “*.m2ts” included in the stream directory STREAM. Particularly, the clip-info files “*.clpi” are recorded with attribute information and timing information of the stream files “*.m2ts”. Each clip-info file “*.clpi” and the stream file “*.m2ts” corresponding to the clip-info file “*.clpi” are collectively referred to as a “clip”. That is, a clip is indicative of data including both one stream file “*.m2ts” and one clip-info file “*.clpi” corresponding to the stream file “*.m2ts”.

The playlist directory PLAYLIST includes a plurality of playlist files “*.mpls”. “Playlist” means a combination of playing intervals of clips. Each playing interval is referred to as a “playitem”. Each playlist file “*.mpls” includes at least one playitem, and may include at least one subplayitem. Each of the playitems and subplayitems includes information as to the reproduction start time IN-Time and reproduction end time OUT-Time of a particular clip to be reproduced. Accordingly, a playlist may be a combination of playitems.

As to the playlist files, a process for reproducing data using at least one playitem in a playlist file is defined as a “main path”, and a process for reproducing data using one subplayitem is defined as a “sub path”. The main path provides master presentation of the associated playlist, and the sub path provides auxiliary presentation associated with the master presentation. Each playlist file should include one main path. Each playlist file also includes at least one sub path, the number of which is determined depending on the presence or absence of subplayitems. Thus, each playlist file is a basic reproduction/management file unit in the overall reproduction/management file structure for reproduction of a desired clip or clips based on a combination of one or more playitems.

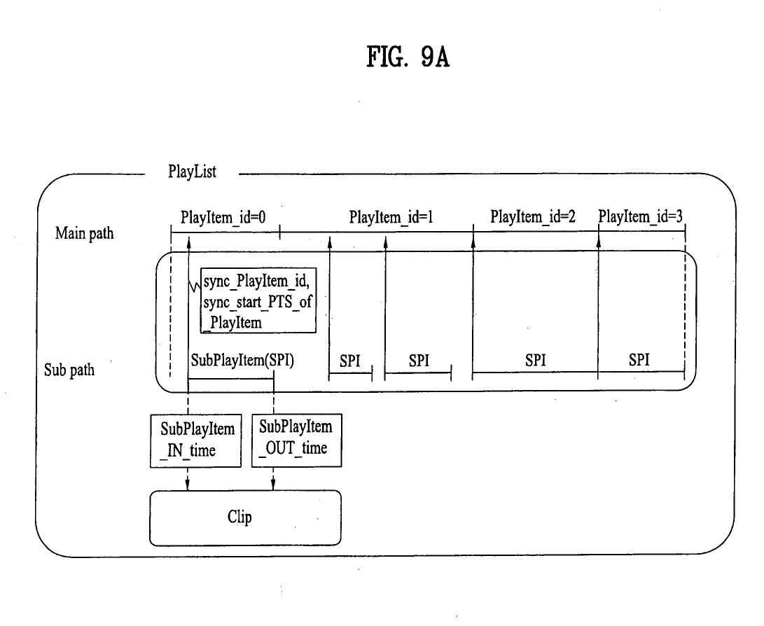

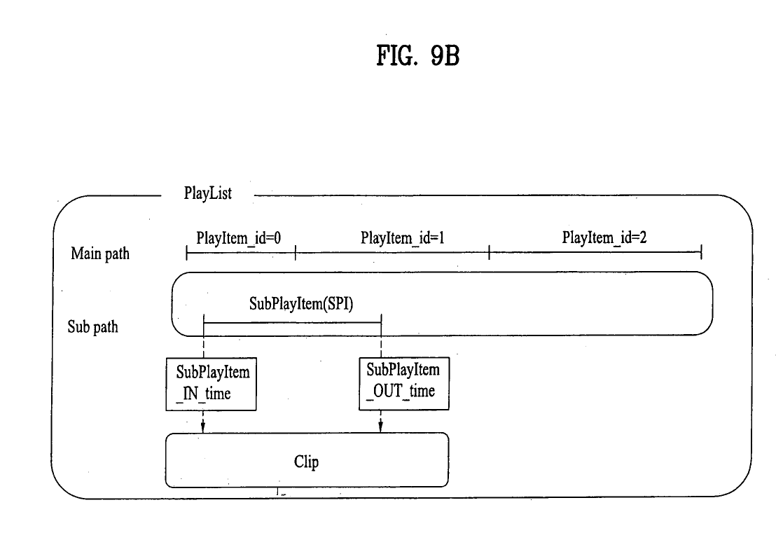

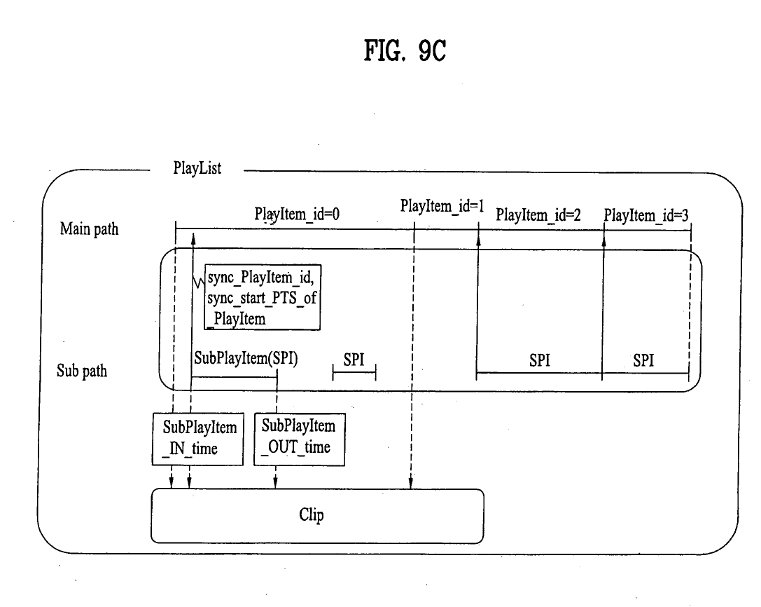

In association with the present invention, video data, which is reproduced through a main path, is referred to as a primary video, whereas video data, which is reproduced through a sub path, is referred to as a secondary video. The function of the optical recording/reproducing apparatus for simultaneously reproducing primary and secondary videos is also referred to as a “picture-in-picture (PiP)”. In association with the present invention, the sub paths, which are used in a data reproduction operation, along with the main path, are mainly classified into three types. This will be described in detail below with reference to FIGS. 9A to 9C.

The backup directory BACKUP stores a copy of the files in the above-described file structure, in particular, copies of files recorded with information associated with playback of the disc, for example, a copy of the index file “index.bdmv”, object files “MovieObject.bdmv” and “BD-JObject.bdmv”, unit key files, all playlist files “*.mpls” in the playlist directory PLAYLIST, and all clip-info files “*.clpi” in the clip-info directory CLIPINF. The backup directory BACKUP is adapted to separately store a copy of files for backup purposes, taking into consideration the fact that, when any of the above-described files is damaged or lost, fatal errors may be generated in association with playback of the disc.

Meanwhile, it will be appreciated that the file structure of the present invention is not limited to the above-described names and locations. That is, the above-described directories and files should not be understood through the names and locations thereof, but should be understood through the meaning thereof.

FIG. 3 illustrates a data recording structure of the optical disc according to an embodiment of the present invention. In FIG. 3, recorded structures of information associated with the file structures in the disc are illustrated. Referring to FIG. 3, it can be seen that the disc includes a file system information area recorded with system information for managing the overall file, an area recorded with the index file, object file, playlist files, clip-info files, and meta files (which are required for reproduction of recorded streams “*.m2ts”), a stream area recorded with streams each composed of audio/video/graphic data or STREAM files, and a JAR area recorded with JAVA program files. The areas are arranged in the above-descried order when viewing from the inner periphery of the disc.

In the disc, there is an area for recording file information for reproduction of contents in the stream area. This area is referred to as a “management area”. The file system information area and database area are included in the management area.

The areas of FIG. 3 are shown and described only for illustrative purposes. It will be appreciated that the present invention is not limited to the area arrangement of FIG. 3.

In accordance with the present invention, stream data of a primary video and/or a secondary video is stored in the stream area. In the present invention, the secondary video may be encoded in the same stream as the primary video (referred to as in-mux), or may be encoded in a stream different from that of the primary video (referred to as out-mux of out-of-mux). The management area may be recorded with information indicating the kind of the stream in which the secondary video is encoded, namely, the encoding type information (out-mux and in-mux) of the secondary video.

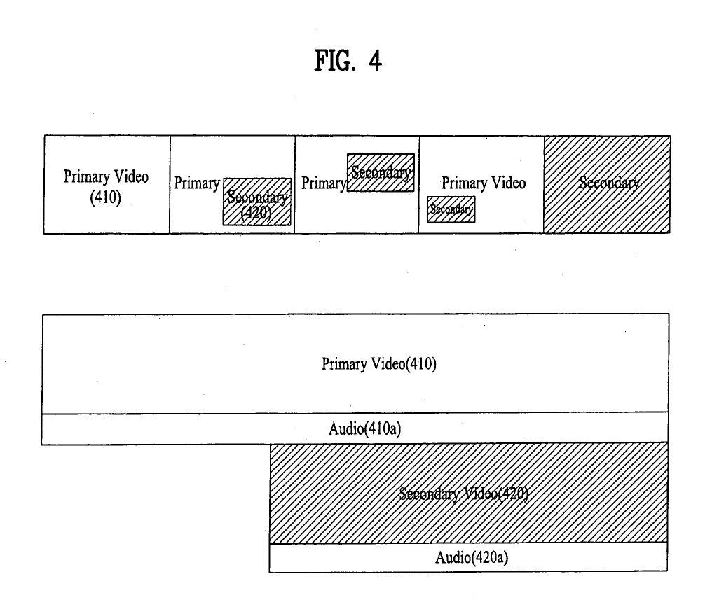

FIG. 4 is a schematic diagram for understanding of the concept of the secondary video according to embodiments of the present invention.

The present invention provides a method for reproducing secondary video data, simultaneously with primary video data. For example, the present invention provides an optical recording/reproducing apparatus that enables a PiP application, and, in particular, effectively performs the PiP application.

During reproduction of a primary video 410 as shown in FIG. 4, it may be necessary to output other video data associated with the primary video 410 through the same display 20 as that of the primary video 410. In accordance with the present invention, such a PiP application can be achieved. For example, during playback of a movie or documentary, it is possible to provide, to the user, the comments of the director or episode associated with the shooting procedure. In this case, the video of the comments or episode is a secondary video 420. The secondary video 420 can be reproduced simultaneously with the primary video 410, from the beginning of the reproduction of the primary video 410.

The reproduction of the secondary video 420 may be begun at an intermediate time of the reproduction of the primary video 410. It is also possible to display the secondary video 420 while varying the position or size of the secondary video 420 on the screen, depending on the reproduction procedure. A plurality of secondary videos 420 may also be implemented. In this case, the secondary videos 420 may be reproduced, separately from one another, during the reproduction of the primary video 410. The primary video 410 can be reproduced along with an audio 410a associated with the primary video 410. Similarly, the secondary video 420 can be reproduced along with an audio 420a associated with the secondary video 420.

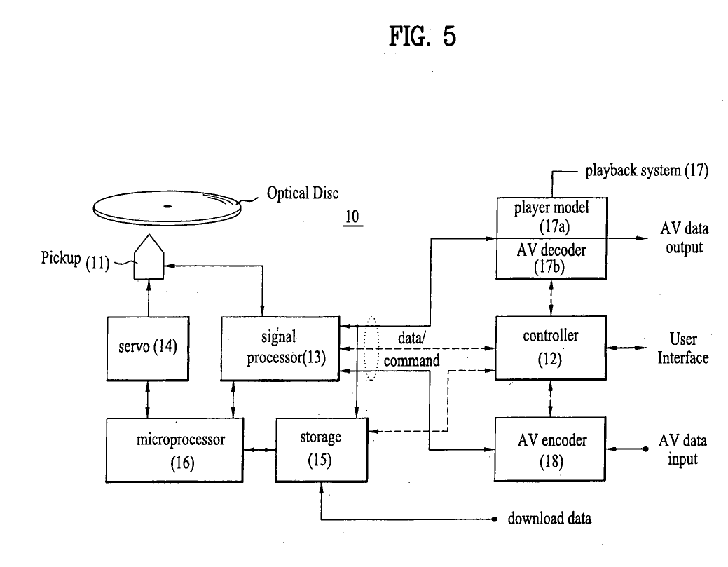

For reproduction of the secondary video, the AV stream, in which the secondary video is multiplexed, is identified and the secondary video is separated from the AV stream, for decoding of the secondary video. Accordingly, information is provided as to the encoding method applied to the secondary video and the kind of the stream in which the secondary video is encoded. Also, information as to whether or not the primary and secondary videos should be synchronous with each other is provided. This presentation path type information (synchronous or asynchronous) may be provided as part of the encoding type information. In addition, a new decoder model should be defined for simultaneous reproduction of the primary and secondary videos. The present invention provides a method capable of satisfying the above-described requirements, and efficiently reproducing the secondary video along with the primary video. Hereinafter, the present invention will be described in detail with reference to FIG. 5 and the remaining drawings.

FIG. 5 illustrates an exemplary embodiment of the overall configuration of the optical recording/reproducing apparatus 10 according to the present invention.

As shown in FIG. 5, the optical recording/reproducing apparatus 10 mainly includes a pickup 11, a servo 14, a signal processor 13, and a microprocessor 16. The pickup 11 reproduces original data and management data recorded in an optical disc. The management data includes reproduction management file information. The servo 14 controls operation of the pickup 11. The signal processor 13 receives a reproduced signal from the pickup 11, and restores the received reproduced signal to a desired signal value. The signal processor 13 also modulates signals to be recorded, for example, primary and secondary videos, to signals recordable in the optical disc, respectively. The microprocessor 16 controls the operations of the pickup 11, the servo 14, and the signal processor 13. The pickup 11, the servo 14, the signal processor 13, and the microprocessor 16 are also collectively referred to as a “recording/reproducing unit”. In accordance with the present invention, the recording/reproducing unit reads data from an optical disc 30 or storage 15 under the control of a controller 12, and sends the read data to an AV decoder 17b. The recording/reproducing unit also receives an encoded signal from an AV encoder 18, and records the received signal in the optical disc 30. Thus, the recording/reproducing unit can record video and audio data in the optical disc 30.

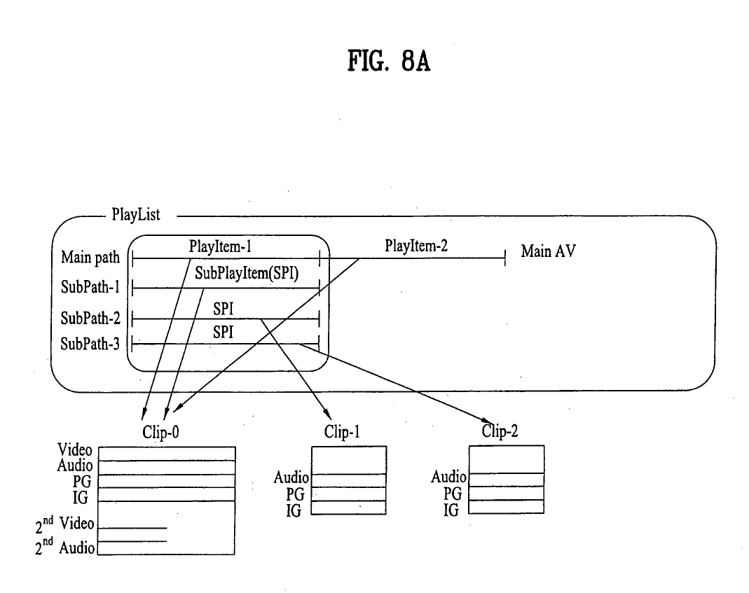

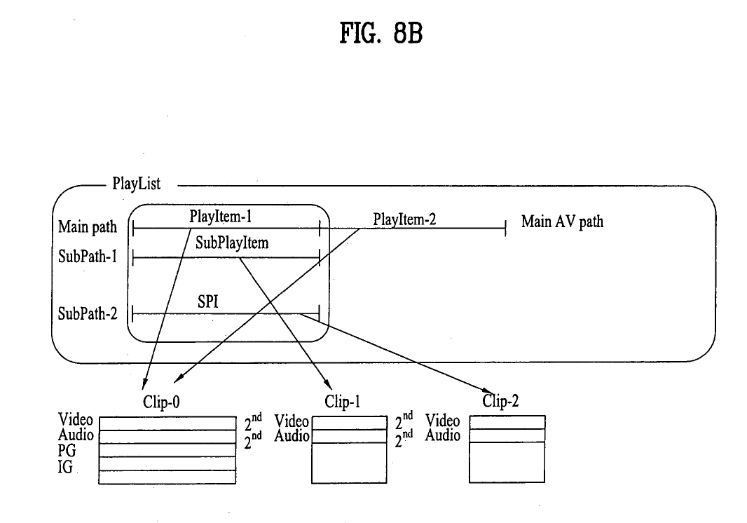

The controller 12 downloads additional data present outside the optical disc 30 in accordance with a user command, and stores the additional data in the storage 15. The controller 12 also reproduces the additional data stored in the storage 15 and/or the original data in the optical disc 30 at the request of the user. In accordance with the present invention, the controller 12 produces encoding type information in accordance with the kind of the stream, in which the secondary video is encoded, and controls the recording/reproducing unit to record the encoding type information in the optical disc 30, along with video data. The encoding type of the secondary video will be described with reference to FIGS. 8A to 8C.

The optical recording/reproducing apparatus 10 further includes a playback system 17 for finally decoding data, and providing the decoded data to the user under the control of the controller 12. The playback system 17 includes an AV decoder 17b for decoding an AV signal. The playback system 17 also includes a player model 17a for analyzing an object command or application associated with playback of a particular title, for analyzing a user command input via the controller 12, and for determining a playback direction, based on the results of the analysis. In an embodiment, the player model 17a may be implemented as including the AV decoder 17a. In this case, the playback system 17 is the player model itself.

The AV encoder 18, which is also included in the optical recording/reproducing apparatus 10 of the present invention, converts an input signal to a signal of a particular format, for example, an MPEG2 transport stream, and sends the converted signal to the signal processor 13, to enable recording of the input signal in the optical disc 30.

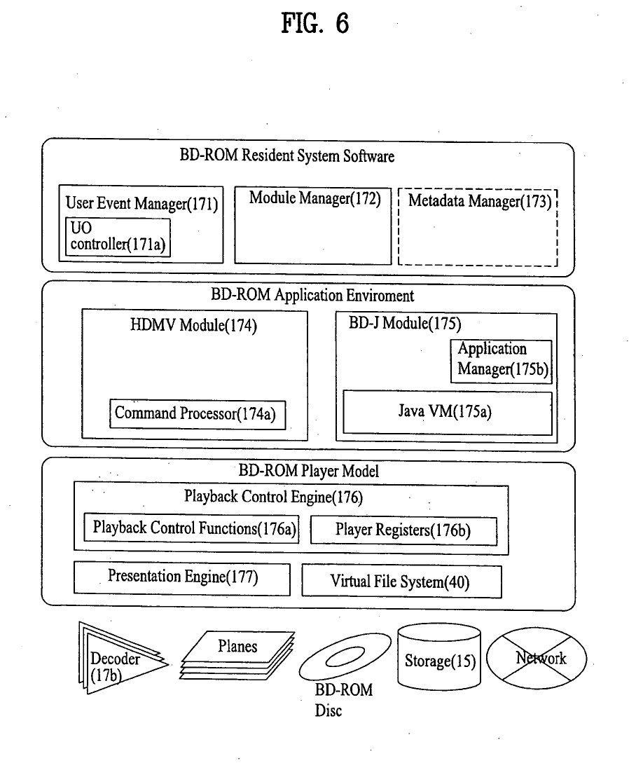

FIG. 6 is a schematic diagram explaining the playback system according to an embodiment of the present invention. In accordance with the present invention, the playback system can simultaneously reproduce the primary and secondary videos.

“Playback system” means a collective reproduction processing means which is configured by programs (software) and/or hardware provided in the optical recording/reproducing apparatus. That is, the playback system is a system which can not only play back a recording medium loaded in the optical recording/reproducing apparatus, but also can reproduce and manage data stored in the storage of the apparatus in association with the recording medium (for example, after being downloaded from the outside of the recording medium).

In particular, as shown in FIG. 6, the playback system 17 may include a user event manager 171, a module manager 172, a metadata manager 173, an HDMV module 174, a BD-J module 175, a playback control engine 176, a presentation engine 177, and a virtual file system 40. This configuration will be described in detail, hereinafter.

As a separate reproduction processing/managing means for reproduction of HDMV titles and BD-J titles, the HDMV module 174 for HDMV titles and the BD-J module 175 for BD-J titles are constructed independently of each other. Each of the HDMV module 174 and BD-J module 175 has a control function for receiving a command or program contained in the associated object “Movie Object” or “BD-J Object”, and processing the received command or program. Each of the HDMV module 174 and BD-J module 175 can separate an associated command or application from the hardware configuration of the playback system, to enable portability of the command or application. For reception and processing of the command, the HDMV module 174 includes a command processor 174a. For reception and processing of the application, the BD-J module 175 includes a Java Virtual Machine (VM) 175a, and an application manager 175b.

The Java VM 175a is a virtual machine in which an application is executed. The application manager 175b includes an application management function for managing the life cycle of an application processed in the BD-J module 175.

The module manager 172 functions not only to send user commands to the HDMV module 174 and BD-J module 175, respectively, but also to control operations of the HDMV module 174 and BD-J module 175. A playback control engine 176 analyzes the playlist file actually recorded in the disc in accordance with a playback command from the HDMV module 174 or BD-J module 175, and performs a playback function based on the results of the analysis. The presentation engine 177 decodes a particular stream managed in association with reproduction thereof by the playback control engine 176, and displays the decoded stream in a displayed picture. In particular, the playback control engine 176 includes playback control functions 176a for managing all playback operations, and player registers 176b for storing information as to the playback status and playback environment of the player (information of player status registers (PSRs) and general purpose registers (GPRs)). In some cases, the playback control functions 176a mean the playback control engine 176 itself.

The HDMV module 174 and BD-J module 175 receive user commands in independent manners, respectively. The user command processing methods of HDMV module 174 and BD-J module 175 are also independent of each other. In order to transfer a user command to an associated one of the HDMV module 174 and BD-J module 175, a separate transfer means should be used. In accordance with the present invention, this function is carried out by the user event manager 171. Accordingly, when the user event manager 171 receives a user command generated through a user operation (UO) controller 171a, the user event manager sends the received user command to the module manager 172 or UO controller 171a. On the other hand, when the user event manager 171 receives a user command generated through a key event, the user event manager sends the received user command to the Java VM 175a in the BD-J module 175.

The playback system 17 of the present invention may also include a metadata manager 173. The metadata manager 173 provides, to the user, a disc library and an enhanced search metadata application. The metadata manager 173 can perform selection of a title under the control of the user. The metadata manager 173 can also provide, to the user, recording medium and title metadata.

The module manager 172, HDMV module 174, BD-J module 175, and playback control engine 176 of the playback system according to the present invention can perform desired processing in a software manner. Practically, the processing using software is advantageous in terms of design, as compared to processing using a hardware configuration. Of course, it is general that the presentation engine 177, decoder 19, and planes are designed using hardware. In particular, the constituent elements (for example, constituent elements designated by reference numerals 172, 174, 175, and 176), each of which performs desired processing using software, may constitute a part of the controller 12. Therefore, it should be noted that the above-described constituents and configuration of the present invention be understood on the basis of their meanings, and are not limited to their implementation methods such as hardware or software implementation. Here, “plane” means a conceptual model for explaining overlaying procedures of the primary video, secondary video, PG (presentation graphics), IG (interactive graphics), text sub titles. In accordance with the present invention, the secondary video plane is arranged in front of the primary video plane. Accordingly, the secondary video output after being decoded is presented on the secondary video plane.

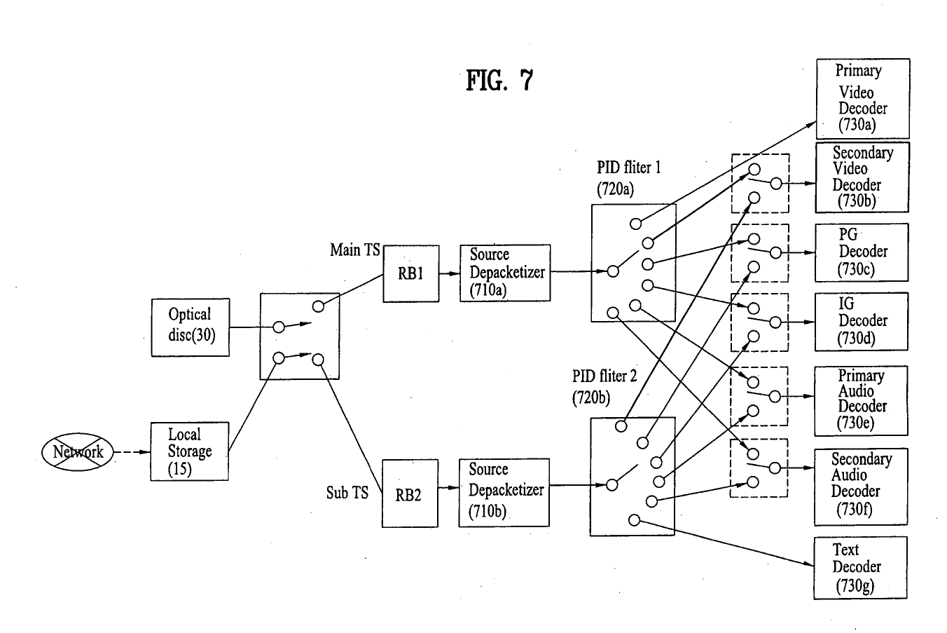

FIG. 7 schematically illustrates the AV decoder 17b according to an embodiment of the present invention.

In accordance with the present invention, the AV decoder 17b includes a secondary video decoder 730b for simultaneous reproduction of the primary and secondary videos, namely, implementation of a PiP application. The secondary video decoder 730b decodes the secondary video. The secondary video may be recorded in the recording medium 30 in a state of being contained in an AV stream, to be supplied to the user. The secondary video may also be supplied to the user after being downloaded from the outside of the recording medium 30. The AV stream is supplied to the AV decoder 17b in the form of a transport stream (TS).

In the present invention, the AV stream, which is reproduced through a main path, is referred to as a main transport stream or main TS (hereinafter, also referred to as a “main stream”), and an AV stream other than the main stream is referred to as a sub transport stream or sub TS (hereinafter, also referred to as a “sub stream”).

In the AV decoder 17b, a main stream from the optical disc 30 passes through a switching element to a buffer RB1, and the buffered main stream is depacketized by a source depacketizer 710a. Data contained in the depacketized AV stream is supplied to an associated one of decoders 730a to 730g after being separated from the depacketized AV stream in a PID (packet identifier) filter-1 720a in accordance with the kind of the data packet. That is, in case that a secondary video is contained in the main stream, the secondary video is separated from other data packets in the main stream by the PID filter-1 720a, and is then supplied to the secondary video decoder 730b. As shown, the packets from the PID filter-1 720a may pass through another switching element before receipt by the decoders 730b-730g.

FIG. 8A illustrates a first embodiment of a method for encoding a secondary video. In this embodiment, the secondary video is encoded together with the primary video. The case in which the secondary video is encoded in the same stream as the primary video, namely, the main stream. This encoding type can be called “in-mux”. In the embodiment of FIG. 8A, the playlist includes one main path and three sub paths. The main path is a presentation path of a main video/audio, and each sub path is a presentation path of video/audio additional to the main video/audio. Playitems ‘PlayItem-1’ and ‘PlayItem-2’ configuring the main path refer to associated clips to be reproduced, and to playing intervals of the clips, respectively. In an STN table of each playitem, elementary streams are defined which are selectable by the optical recording/reproducing apparatus of the present invention during the presentation of the playitem. The playitems ‘PlayItem-1’ and ‘PlayItem-2’ refer to a clip ‘Clip-0’. Accordingly, the clip ‘Clip-0’ is reproduced for the playing intervals of the playitems ‘PlayItem-1’ and ‘PlayItem-2’. Since the clip ‘Clip-0’ is reproduced through the main path, the clip ‘Clip-0’ is supplied to the AV decoder 17b as a main stream.

Each of the sub paths ‘SubPath-1’, ‘SubPath-2’, and ‘SubPath-3’ associated with the main path is configured by a single associated subplayitem. The subplayitem of each sub path refers to a clip to be reproduced. In the illustrated case, the sub path ‘SubPath-1’ refers to the clip ‘Clip-0’, the sub path ‘SubPath-2’ refers to a clip ‘Clip-1’, and the sub path ‘SubPath-3’ refers to a clip ‘Clip-2’. That is, the sub path ‘SubPath-1’ uses secondary video and audio streams included in the clip ‘Clip-0’. On the other hand, each of the sub paths ‘SubPath-2’ and ‘SubPath-3’ uses audio, PG, and IG streams included in the clip referred to by the associated subplayitem.

In the embodiment of FIG. 8A, the secondary video is encoded in the clip ‘Clip-0’ to be reproduced through the main path. Accordingly, the secondary video is supplied to the AV decoder 17b, along with the primary video, as a main stream. In the AV decoder 17b, the secondary video is supplied to the secondary video decoder 730b via the PID filter-1, and is then decoded by the secondary video decoder 730b. In addition, the primary video of the clip ‘Clip-0’ is decoded in a primary video decoder 730a, and the primary audio is decoded in a primary audio decoder 730e. Also, the PG (presentation graphics), IG (interactive graphics), and secondary audio are decoded in a PG decoder 730c, an IG decoder 730d, and a secondary audio decoder 730f, respectively.

FIG. 8B illustrates a second embodiment of the method for encoding the secondary video. In this embodiment, the secondary video is encoded in a stream different from that of the primary video.

In the embodiment of FIG. 8B, the playlist includes one main path and two sub paths ‘SubPath-1’ and ‘SubPath-2’. Playitems ‘PlayItem-1’ and ‘PlayItem-2’ are used to reproduce elementary streams included in a clip ‘Clip-0’. Each of the sub paths ‘SubPath-1’ and ‘SubPath-2’ is configured by a single associated subplayitem. The subplayitems of the sub paths ‘SubPath-1’ and ‘SubPath-2’ refer to clips ‘Clip-1’ and ‘Clip-2’, respectively. In case that the ‘SubPath-1’ is presented along with the main path, the secondary video referred to by the sub path ‘SubPath-1’ is reproduced along with the primary video referred to by the main path. On the other hand, when the ‘SubPath-2’ is presented along with the main path, the secondary video referred to by the sub path ‘SubPath-2’ is reproduced along with the primary video.

In the embodiment of FIG. 8B, the secondary video is contained in a stream other than the stream which is reproduced through the main path. Accordingly, streams of the encoded secondary video, namely, the clips ‘Clip-1’ and ‘Clip-2’, are supplied to the AV decoder 17b as sub streams. The case in which the secondary video is encoded in a stream different from that of the primary video, as described above, is referred to as an ‘out-of-mux’.

In the AV decoder 17b, each sub stream from the optical disc 30 or local storage 15 passes through a switching element to a buffer RB2, the buffered sub stream is depacketized by a source depacketizer 710b. Data contained in the depacketized AV stream is supplied to an associated one of the decoders 730a to 730g after being separated from the depacketized AV stream in a PID filter-2 720b in accordance with the kind of the data packet. As shown, the packets from the PID filter-2 720b may pass through another switching element before receipt by the decoders 730b-730f. For example, when the ‘SubPath-1’ is presented along with the main path, the secondary video included in the clip ‘Clip-1’ is supplied to the secondary video decoder 730b after being separated from secondary audio packets, and is then decoded by the secondary video decoder 730b. In this case, the secondary audio is supplied to the secondary audio decoder 730f, and is then decoded by the secondary audio decoder 730f. The decoded secondary video is displayed on the primary video, which is displayed after being decoded by the primary video decoder 730a. Accordingly, the user can view both the primary and secondary videos through the display 20.

Referring to the description given with reference to FIGS. 7 to 8B, it can be seen that the presentation path of the secondary video is varied depending on the encoding method for the secondary video. In this regard, the presentation paths for the secondary video according to the present invention may be mainly classified into three types. Hereinafter, the presentation path types for the secondary video according to the present invention will be described with reference to FIGS. 9A to 9C.

FIG. 9A illustrates the case in which the encoding type of the secondary video is the ‘out-of-mux’ type, and the secondary video is synchronous with the primary video.

Referring to FIG. 9A, the playlist for managing the primary and secondary videos includes one main path and one sub path. The main path is configured by four playitems (‘PlayItem_id’=0, 1, 2, 3), whereas the sub path is configured by a plurality of subplayitems. The secondary video, which is reproduced through the sub paths, is synchronous with the main path. In detail, the secondary video is synchronized with the main path, using an information field ‘sync-PlayItem_{—id}’, which identifies a playitem associated with each subplayitem, and a presentation time stamp information ‘sync_start_PTS_of_PlayItem’, which indicates a presentation time of the subplayitem in the playitem. That is, when the presentation point of the playitem reaches a value referred to by the presentation time stamp information, the presentation of the associated subplayitem is begun. Thus, reproduction of the secondary video through one sub path is begun at a time during the presentation of the primary video through the main path.

In this case, the playitem and subplayitem refer to different clips, respectively. The clip referred to by the playitem is supplied to the AV decoder 17b as a main stream, whereas the clip referred to by the subplayitem is supplied to the AV decoder 17b as a sub stream. The primary video contained in the main stream is decoded by the primary video decoder 730a after passing through the depacketizer 710a and PID filter-1 720a. On the other hand, the secondary video contained in the sub stream is decoded by the secondary video decoder 730b after passing through the depacketizer 710b and PID filter-2 720b.

FIG. 9B illustrates the case in which the encoding type of the secondary video is the ‘out-of-mux’ type, and the secondary video is asynchronous with the primary video. Similar to the presentation path type of FIG. 9A, secondary video streams, which will be reproduced through sub paths, are multiplexed in a state separate from a clip to be reproduced based on the associated playitem. However, the presentation path type of FIG. 9B is different from the presentation path type of FIG. 9A in that the presentation of the sub path can be begun at any time on the time line of the main path.

Referring to FIG. 9B, the playlist for managing the primary and secondary videos includes one main path and one sub path. The main path is configured by three playitems (‘PlayItem_id’=0, 1, 2), whereas the sub path is configured by one subplayitem. The secondary video, which is reproduced through the sub path, is asynchronous with the main path. That is, even when the subplayitem includes information for identifying a playitem associated with the subplayitem and presentation time stamp information indicating a presentation time of the subplayitem in the playitem, these informations are not valid in the presentation path type of FIG. 9B. Thus, reproduction of the secondary video through one sub path is begun at any time during the reproduction of the primary video. Accordingly, the user can view the secondary video at any time during the reproduction of the primary video.

In this case, since the encoding type of the secondary video is the ‘out-of-mux’ type, the primary video is supplied to the AV decoder 17b as a main stream, and the secondary video is supplied to the AV decoder 17b as a sub stream, as described above with reference to FIG. 9A.

FIG. 9C illustrates the case in which the encoding type of the secondary video is the ‘in-mux’ type, and the secondary video is synchronous with the primary video. The presentation path type of FIG. 9C is different from those of FIGS. 9A and 9B in that the secondary video is multiplexed in the same AV stream as the primary video.

Referring to FIG. 9C, the playlist for managing the primary and secondary videos includes one main path and one sub path. The main path is configured by four playitems (‘PlayItem_id’=0, 1, 2, 3), whereas the sub path is configured by a plurality of subplayitems. Each of the subplayitems configuring the sub path includes information for identifying a playitem associated with the subplayitem, and presentation time stamp information indicating a presentation time of the subplayitem in the playitem. As described above with reference to FIG. 9A, each subplayitem is synchronized with the associated playitem, using the above-described information. Thus, the secondary video is synchronized with the primary video.

In the presentation path type of FIG. 9C, each of the playitems configuring the main path and an associated one or ones of the subplayitems configuring the sub path refer to the same clip. That is, the sub path is presented using a stream included in the clip managed by the main path. Since the clip is managed by the main path, the clip is supplied to the AV decoder 17b as a main stream. The main stream, which is packetized data including primary and secondary videos, is sent to the depacketizer 710a which, in turn, depacketizes the packetized data. The depacketized primary and secondary videos are supplied to the primary and secondary video decoders 730a and 730b in accordance with associated packet identifying information, and are then decoded by the primary and secondary video decoders 730a and 730b, respectively.

The main stream and sub stream may be supplied from the recording medium 30 or storage 15 to the AV decoder 17b. Where the primary and secondary videos are stored in different clips, respectively, the primary video may be recorded in the recording medium 30, to be supplied to the user, and the secondary video may be downloaded from the outside of the recording medium 30 to the storage 15. Of course, the case opposite to the above-described case may be possible. However, where both the primary and secondary videos are stored in the recording medium 30, one of the primary and secondary videos may be copied to the storage 15, prior to the reproduction thereof, in order to better enable the primary and secondary videos to be simultaneously reproduced. Where both the primary and secondary videos are stored in the same clip, they are supplied after being recorded in the recording medium 30. In this case, however, it is possible that both the primary and secondary videos are downloaded from outside of the recording medium 30.

Meanwhile, the optical recording/reproducing apparatus 10 has a maximum transport stream bit rate set to a specific value (for example, 48 Mbps) or set to a predetermined value. Accordingly, the bit rate of a transport stream, which is decoded, cannot exceed the set value. In case that the secondary video is reproduced with the primary video asynchronously after being supplied from the storage 15, the set value is applied to both the stream containing the primary video and the stream containing the secondary video. For example, where the set value is 48 Mbps, the primary video is a stream having a bit rate of 40 Mbps, and the secondary video is downloaded from a network and has a bit rate of 30 Mbps, the total bit rate in this case may exceed the set value of, for example, 48 Mbps, because the total bit rate is 70 Mbps. In this case, it is not possible to reproduce the secondary video harmoniously with the primary video, due to a restriction caused by the set bit rate. To this end, in accordance with an embodiment of the present invention, the total bit rate of the transport streams, which are simultaneously decoded, are prevented from exceeding the set bit rate. Where the secondary video is synchronous with the primary video, the content provider should provide content, taking into consideration the combination of the bit rates of the primary and secondary videos. Even in the case in which the presentation path of the secondary video is asynchronous with the primary video, the set bit rate should be taken into consideration.

Meanwhile, the primary and secondary videos can be encoded to a high definition (HD) grade or to a standard definition (SD) grade. In this regard, a restricted bit rate can be set with respect to the set bit rate in accordance with a combination of HD and SD videos. For example, for a primary video of an HD grade and a secondary video of an HD grade, the maximum bit rates thereof may be set to 20 Mbps or less, respectively. On the other hand, for a primary video of an HD grade and a secondary video of an SD grade, the maximum bit rates thereof may be set to 30 Mbps or less and 15 Mbps or less, respectively. A similar restriction of bit rates may be applied to a combination of a primary video of an SD grade and a secondary video of an HD grade, and a combination of a primary video of an SD grade and a secondary video of an SD grade.

Furthermore, the secondary video should have a same scan type (e.g., progressive or interlaced) as the primary video.

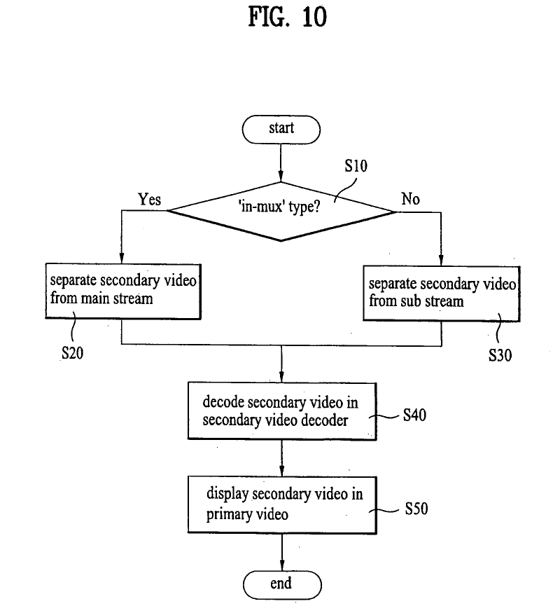

FIG. 10 illustrates an exemplary embodiment of a data reproducing method according to the present invention.

In accordance with the data reproducing method, when a playlist is executed, presentation of the main and sub paths included in the playlist is begun. In order to display a secondary video on a primary video in accordance with the present invention, the sub path used to reproduce the secondary video should be presented along with the main path used to reproduce the primary video. Accordingly, the controller 12 checks whether the secondary video is encoded in a main stream, based on the encoding type information of the secondary video (S10). For example, as discussed above, encoding type information may be provided indicating the type of subpath (e.g., out-of-mux or in-mux). Alternatively, the type of subpath may be determined based on whether the subplayitem associated with a subpath identifies the same clip as a playitem in the main path. In case that the secondary video is encoded in the main stream, namely, where the encoding type of the secondary video is an ‘in-mux’ type, the secondary video is separated from the main stream, and is then sent to the secondary video decoder 730b (S20). On the other hand, in case that the secondary video is encoded in a sub stream, namely, where the encoding type of the secondary video is an ‘out-of-mux’ type, the secondary video is separated from the sub stream, and is then sent to the secondary video decoder 730b (S30). After being decoded by the secondary video decoder 730b (S40), the secondary video is displayed on the primary video, which is being displayed on the display 20 (S50).

Meanwhile, in case that the presentation path type of the secondary video corresponds to the presentation path type of FIG. 9A, the controller 12 controls the AV decoder 17b to decode the secondary video synchronously with the primary video. On the other hand, in case that the presentation path type of the secondary video corresponds to the presentation path type of FIG. 9B, the controller 12 controls the AV decoder 17b to decode the secondary video at any time during the reproduction of the primary video, for example, in response to user input.

In case that the primary video is displayed on the display 20, it can be scanned in an interlaced type or in a progressive type. In accordance with the present invention, the secondary video uses the same scan type (scanning scheme) as the primary video. That is, when the primary video is scanned in a progressive type, the secondary video is also scanned in a progressive manner on the display 20. On the other hand, in case that the primary video is scanned in an interlaced type, the secondary video is also scanned in an interlaced type on the display 20.

As apparent from the above description, in accordance with the recording medium, data reproducing method and apparatus, and data recording method and apparatus of the present invention, it is possible to reproduce the secondary video simultaneously with the primary video. In addition, the reproduction can be efficiently carried out. Accordingly, there are advantages in that the content provider can compose more diverse contents, to enable the user to experience more diverse contents.

It will be apparent to those skilled in the art that various modifications and variations can be made in the present invention without departing from the spirit or scope of the inventions. Thus, it is intended that the present invention covers the modifications and variations of this invention.

What is claimed is:

1. A method of decoding picture-in-picture video data reproduced from a recording medium, comprising:
decoding a primary video stream in data reproduced from the recording medium using a first decoder; and
decoding a secondary video stream in the reproduced data using a second decoder, the secondary video stream representing picture-in-picture video data with respect to the primary video stream.

2. The method of claim 1, further comprising:
reproducing a main path data stream from a data file recorded on the recording medium, the main path data stream including the primary and secondary video streams.

3. The method of claim 2, further comprising:
separating the primary video stream from the main path data stream based on packet identifiers in data packets of the main path data stream; and
separating the secondary video stream from the main path data stream based on the packet identifiers in the data packets of the main path data stream; and wherein
the decoding a primary video stream step decodes the separated primary video stream; and
the decoding a secondary video stream step decodes the separated secondary video stream.

4. The method of claim 2, further comprising:
determining whether the secondary video stream is recorded in a same data file as the primary video stream based on type information recorded on the recording medium; and wherein
the reproducing step reproduces the main path data stream based on the determining step.

5. The method of claim 2, further comprising:
displaying the secondary video stream synchronously with the primary video stream based on type information recorded on the recording medium.

6. The method of claim 5, further comprising:
determining a playitem of the primary video stream with which to reproduce the secondary video stream based on an identifier recorded on the recording medium if the type information indicates to present the secondary video stream synchronously with the primary video stream; and wherein
the displaying step displays the secondary video stream synchronously with the primary video stream based on the type information and the identifier.

7. The method of claim 1, further comprising:
reproducing a main path data stream from a first data file recorded on the recording medium, the main path data stream including the primary video stream; and
reproducing a sub path data stream from a second data file recorded on the recording medium, the second data file being separate from the first data file, and the sub path data stream including the secondary video stream.

8. The method of claim 7, further comprising:
separating the primary video stream from the main path data stream based on packet identifiers in data packets of the main path data stream; and
separating the secondary video stream from the sub path data stream based on packet identifiers in data packets of the sub path data stream; and wherein
the decoding a primary video stream step decodes the separated primary video stream; and
the decoding a secondary video stream step decodes the separated secondary video stream.

9. The method of claim 7, further comprising:
determining whether the secondary video stream is recorded in a same data file as the primary video stream based on type information recorded on the recording medium; and wherein
the reproducing a main path data stream step reproduces the main path data stream based on the determining step; and
the reproducing a sub path data stream step reproduces the sub path data stream based on the determining step.

10. The method of claim 7, further comprising:
displaying the secondary video stream synchronously with the primary video stream based on type information recorded on the recording medium.

11. The method of claim 10, further comprising:
determining a playitem of the primary video stream with which to reproduce the secondary video stream based on an identifier recorded on the recording medium if the type information indicates to present the secondary video stream synchronously with the primary video stream; and wherein
the displaying step displays the secondary video stream synchronously with the primary video stream based on the type information and the identifier.

12. The method of claim 11, further comprising:
determining a presentation timing of the secondary video stream based on presentation timing information recorded on the recording medium if the type information indicates to present the secondary video stream synchronously with the primary video stream; and wherein
the displaying step displays the secondary video stream synchronously with the primary video stream based on the type information, the identifier and the presentation timing information.

13. The method of claim 10, further comprising:
determining a presentation timing of the secondary video stream based on presentation timing information recorded on the recording medium if the type information indicates to present the secondary video stream synchronously with the primary video stream; and wherein
the displaying step displays the secondary video stream synchronously with the primary video stream based on the type information and the presentation timing information.

14. The method of claim 7, further comprising:
displaying the secondary video stream asynchronously with the primary video stream based on type information recorded on the recording medium.

15. The method of claim 1, wherein a sum of bit rates of the primary and secondary video streams is less than or equal to a set value.

16. The method of claim 1, wherein the secondary video stream has a same scan type as the primary video stream.

17. A method of decoding picture-in-picture video data, comprising:
decoding a primary video stream in data reproduced from a recording medium using a first decoder;
receiving the sub path data stream from an external source other than the recording medium;
storing the sub path data stream including at least a secondary video stream, the secondary video stream predetermined to serve as a picture-in-picture data with respect to the primary video stream; and
decoding the secondary video stream using a second decoder.

18. A method of processing picture-in-picture video data reproduced from a recording medium, comprising:
separating a primary video stream from a main path data stream reproduced from the recording medium;
supplying the primary video stream to a first decoder;
separating a secondary video stream from one of the main path data stream and a sub path data stream reproduced from the recording medium, the secondary video stream representing picture-in-picture video data with respect to the primary video stream; and
supplying the secondary video stream to a second decoder.

19. A recording medium having a data structure for managing decoding of picture-in-picture video data stored on the recording medium, comprising:
a data area storing a primary video stream and a secondary video stream, the secondary video stream representing picture-in-picture video data with respect to the primary video stream; and
a management area storing management information for managing reproduction of the primary and secondary video streams such that the secondary video stream is decoded using a different decoder than a decoder used to decode the primary video stream.

20. The recording medium of claim 19, wherein the managing information includes type information indicating whether the primary and secondary video streams are stored in a same data file.

21. The recording medium of claim 20, wherein the type information indicates whether to display the secondary video stream synchronously with the primary video stream.

22. The recording medium of claim 19, wherein the managing information includes type information indicating whether to display the secondary video stream one of synchronously and asynchronously with the primary video stream.

23. An apparatus for decoding picture-in-picture video data reproduced from a recording medium, comprising:
a first decoder configured to decode a primary video stream in data reproduced from the recording medium; and
a second decoder configured to decode a secondary video stream in the reproduced data, the secondary video stream representing picture-in-picture video data with respect to the primary video stream.

24. The apparatus of claim 23, further comprising:
a filter separating the primary video stream from the main path data stream, and separating the secondary video stream from the main path data stream; and wherein
the first decoder decodes the separated primary video stream; and
the second decoder decodes the separated secondary video stream.

25. The apparatus of claim 24, wherein
the filter separates the primary and secondary video streams based on packet identifiers in data packets of the main path data stream.

26. The apparatus of claim 24, further comprising:
a controller determining whether the secondary video stream is recorded in a same data file as the primary video stream based on type information recorded on the recording medium, and controlling reproduction of the main path data stream based on the determination.

27. The apparatus of claim 24, wherein the second decoder decodes the secondary video stream such that the secondary video stream is displayed synchronously with the primary video stream based on the type information recorded on the recording medium.

28. The apparatus of claim 23, further comprising:
a first filter separating the primary video stream from the main path data stream; and
a second filter separating the secondary video stream from the sub path data stream; and wherein
the first decoder decodes the separated primary video stream; and
the second decoder decodes the separated secondary video stream.

29. The apparatus of claim 28, wherein
the first filter separates the primary video stream based on packet identifiers in data packets of the main path data stream; and
the second filter separates the secondary video stream based on the packet identifiers in the data packets of the sub path data stream.

30. The apparatus of claim 28, further comprising:
a controller determining whether the secondary video stream is recorded in a separate data file as the primary video stream based on type information recorded on the recording medium, and controlling reproduction of the main and sub path data stream based on the determination.

31. The apparatus of claim 28, wherein the second decoder decodes the secondary video stream such that the secondary video stream is displayed synchronously with the primary video stream based on the type information recorded on the recording medium.

32. An apparatus for decoding picture-in-picture video data, comprising:
a first decoder decoding a primary video stream in data reproduced from a recording medium;
a local storage receiving the sub path data stream from an external source other than the recording medium, and storing the sub path data stream including at least a secondary video stream, the secondary video stream predetermined to serve as a picture-in-picture data with respect to the primary video stream; and
a second decoder decoding the secondary video stream

33. The apparatus of claim 32, further comprising:
a first filter separating the primary video stream from the main path data stream; and
a second filter separating the secondary video stream from the stored sub path data stream; and wherein
the first decoder decodes the separated primary video stream; and
the second decoder decodes the separated secondary video stream.

34. The apparatus of claim 33, wherein
the first filter separates the primary video stream based on packet identifiers in data packets of the main path data stream; and
the second filter separates the secondary video stream based on the packet identifiers in the data packets of the sub path data stream.

35. A method of recording picture-in-picture video data on a recording medium, comprising:
recording a primary video stream and a secondary video stream on the recording medium, the secondary video stream representing picture-in-picture video data with respect to the primary video stream; and
recording management information on the recording medium, the management information for managing reproduction of the primary and secondary video streams such that the secondary video stream is decoded using a different decoder than a decoder used to decode the primary video stream.

36. The method of claim 35, wherein the managing information includes type information indicating whether the primary and secondary video streams are stored in a same data file.

37. The method of claim 35, wherein the management information includes type information indicating whether to display the secondary video stream synchronously with the primary video stream.

38. An apparatus for recording picture-in-picture video data on a recording medium, comprising:
a driver configured to drive a recording device to record data on the recording medium;
a controller configured to control the driver to record a primary video stream and a secondary video stream on the recording medium, the secondary video stream representing picture-in-picture video data with respect to the primary video stream; and
the controller configured to record management information on the recording medium, the management information for managing reproduction of the primary and secondary video streams such that the secondary video stream is decoded using a different decoder than a decoder used to decode the primary video stream.

39. The apparatus of claim 38, wherein the management information includes type information indicating whether to display the secondary video stream synchronously with the primary video stream.

40. The apparatus of claim 38, wherein the managing information includes type information indicating whether the primary and secondary video streams are stored as separate data files.

41. The apparatus of claim 40, wherein the type information indicates whether to display the secondary video stream one of synchronously and asynchronously with the primary video stream.
